(19) United States
(12) Patent Application Publication
(10) Pub. No.: US 2025/0342847 A1
(43) Pub. Date: Nov. 6, 2025

(54) METHOD FOR BANDWIDTH EXTENSION OF AUDIO SIGNAL AND APPARATUS FOR PERFORMING THE SAME

(71) Applicant: Electronics and Telecommunications Research Institute, Daejeon (KR)

(72) Inventors: Jongmo SUNG, Daejeon (KR); Soo Young PARK, Daejeon (KR); Seung Kwon BEACK, Daejeon (KR); Woo-taek LIM, Daejeon (KR); Inseon JANG, Daejeon (KR); Byeongho CHO, Daejeon (KR)

(73) Assignee: Electronics and Telecommunications Research Institute, Daejeon (KR)

(21) Appl. No.: 19/194,103

(22) Filed: Apr. 30, 2025

(30) Foreign Application Priority Data
May 2, 2024 (KR) 10-2024-0058368

(51) Int. Cl. G10L 19/06; G10L 19/02

(52) U.S. Cl. CPC G10L 19/06; G10L 19/0204

(57) ABSTRACT

A method of extending a bandwidth of an audio signal is provided. The method includes obtaining low-band patches in which a low-band spectrum corresponding to a low-band signal is segmented, generating a key parameter and a value parameter based on the low-band patches, predicting high-band patches from the low-band patches based on the key parameter and the value parameter, and generating a full-band spectrum based on the predicted high-band patches and the low-band spectrum.

### CROSS-REFERENCE TO RELATED APPLICATION

This application claims the benefit of Korean Patent Application No. 10-2024-0058368, filed on May 2, 2024, in the Korean Intellectual Property Office, the entire disclosure of which is incorporated herein by reference for all purposes.

### BACKGROUND

### 1. Field of the Invention

One or more embodiments relate to a method of extending a bandwidth of an audio signal and a device for performing the same.

### 2. Description of the Related Art

Bandwidth extension of an audio signal may be technology of extending a bandwidth by restoring a wide-band signal from a narrow-band signal. The bandwidth extension may be used to improve bit efficiency for transmission and storage of the audio signal. Spectrum band replication (SBR), one of the bandwidth extension methods, is technology of replicating a low-band spectrum and restoring the low-band spectrum to a high-band spectrum by performing scaling. A bandwidth extension method based on a neural network may be technology of generating a high-band signal or a high-band spectrum from a low-band signal or a low-band spectrum through a neural network. Bandwidth extension technology may be required for efficient compression of the audio signal and improved restoration quality.

The above description has been possessed or acquired by the inventor(s) in the course of conceiving the present disclosure and is not necessarily an art publicly known before the present application is filed.

### SUMMARY

Embodiments provide technology of restoring a full-band signal with an extended bandwidth from a low-band signal.

Embodiments provide extension of a bandwidth of an audio signal using a transformer neural network.

However, technical goals are not limited to the aforementioned goals, and other technical aspects may be present.

According to an aspect, there is provided a method including obtaining low-band patches in which a low-band spectrum corresponding to a low-band signal is segmented, generating a key parameter and a value parameter based on the low-band patches, predicting high-band patches from the low-band patches based on the key parameter and the value parameter, and generating a full-band spectrum based on the predicted high-band patches and the low-band spectrum.

The generating of the key parameter and the value parameter may include inputting the low-band patches to a transformer encoder to generate the key parameter and the value parameter.

The obtaining of the low-band patches may include applying a patch window to the low-band spectrum to obtain the low-band patches.

The key parameter and the value parameter may be calculated based on attention weights between the low-band patches.

The predicting of the high-band patches may include predicting a first high-band patch from a first patch sequence using a transformer decoder and generating a second patch sequence by concatenating the first patch sequence with the first high-band patch.

The method may further include predicting a second high-band patch from the second patch sequence using the transformer decoder.

The first high-band patch may include a previous high-band patch, and the second high-band patch may include a current high-band patch.

The generating of the full-band spectrum may include generating a high-band spectrum based on the predicted high-band patches and synthesizing the low-band spectrum with the high-band spectrum to generate the full-band spectrum.

The generating of the high-band spectrum may include generating a high-band magnitude spectrum by synthesizing the predicted high-band patches, estimating a high-band phase spectrum based on the high-band magnitude spectrum, and generating the high-band spectrum based on the high-band magnitude spectrum and the high-band phase spectrum.

The method may further include generating a full-band signal corresponding to the full-band spectrum.

According to another aspect, there is provided a device including a memory including instructions and a processor electrically connected to the memory and configured to execute the instructions, wherein, when the instructions are executed by the processor, the processor may be configured to control a plurality of operations, wherein the plurality of operations may include obtaining low-band patches in which a low-band spectrum corresponding to a low-band signal is segmented, generating a key parameter and a value parameter based on the low-band patches, predicting high-band patches from the low-band patches based on the key parameter and the value parameter, and generating a full-band spectrum based on the predicted high-band patches and the low-band spectrum.

The generating of the key parameter and the value parameter may include inputting the low-band patches to a transformer encoder to generate the key parameter and the value parameter.

The obtaining of the low-band patches may include applying a patch window to the low-band spectrum to obtain the low-band patches.

The key parameter and the value parameter may be calculated based on attention weights between the low-band patches.

The predicting of the high-band patches may include predicting a first high-band patch from a first patch sequence using a transformer decoder and generating a second patch sequence by concatenating the first patch sequence with the first high-band patch.

The device may further include predicting a second high-band patch from the second patch sequence using the transformer decoder.

The first high-band patch may include a previous high-band patch, and the second high-band patch may include a current high-band patch.

The generating of the full-band spectrum may include generating a high-band spectrum based on the predicted high-band patches and synthesizing the low-band spectrum with the high-band spectrum to generate the full-band spectrum.

The generating of the high-band spectrum may include generating a high-band magnitude spectrum by synthesizing the predicted high-band patches, estimating a high-band phase spectrum based on the high-band magnitude spectrum, and generating the high-band spectrum based on the high-band magnitude spectrum and the high-band phase spectrum.

The plurality of operations may further include generating a full-band signal corresponding to the full-band spectrum.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic block diagram of a bandwidth extension device according to an embodiment;

FIG. 2 is a diagram illustrating a bandwidth extension method according to an embodiment;

FIG. 3 is a diagram illustrating an operation of generating parameters, according to an embodiment;

FIG. 4 is a diagram illustrating an operation of predicting a high-band patch, according to an embodiment;

FIG. 5 is a diagram illustrating an operation of generating a full-band spectrum, according to an embodiment;

FIG. 6 is a diagram illustrating a patch segmentation operation according to an embodiment;

FIG. 7 is a diagram illustrating an operation of training a neural network, according to an embodiment;

FIG. 8 is a flowchart illustrating a method of extending a bandwidth of an audio signal, according to an embodiment; and

FIG. 9 is a schematic block diagram of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like elements and a repeated description related thereto will be omitted.

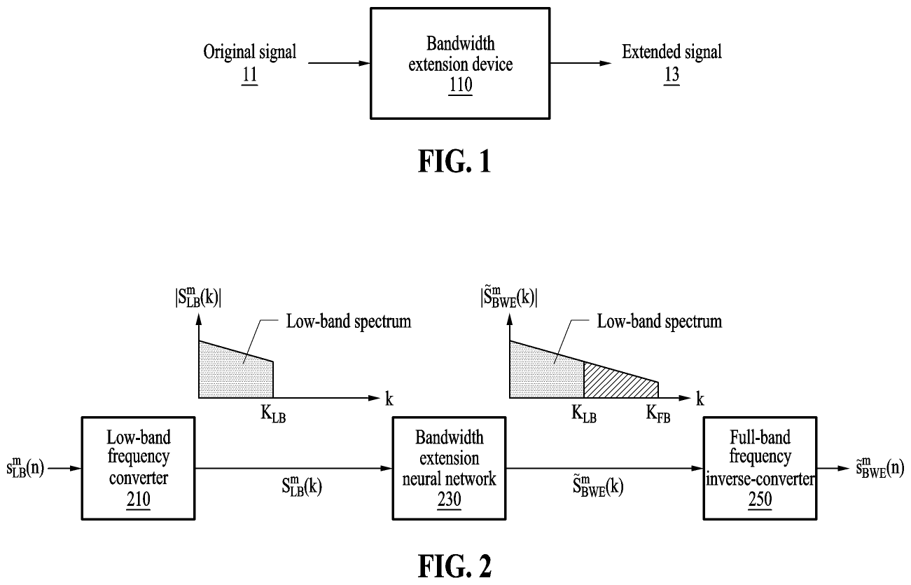

FIG. 1 is a schematic block diagram of a bandwidth extension device according to an embodiment.

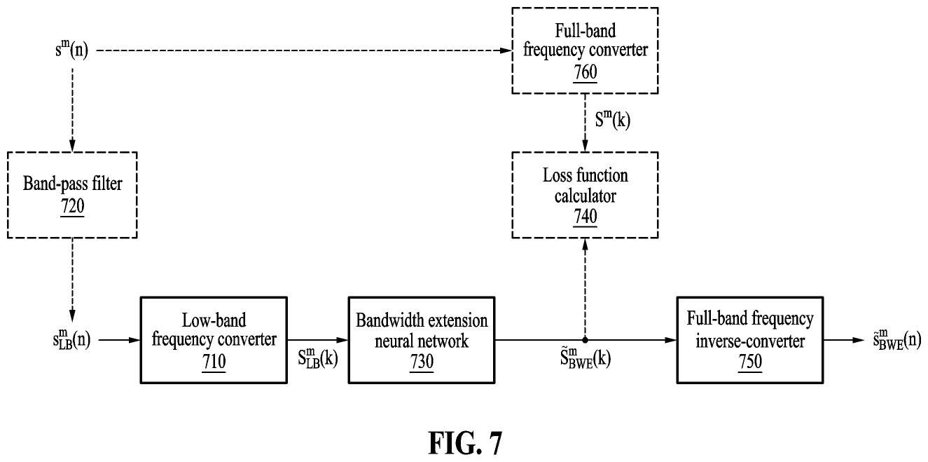

Referring to FIG. 1, according to an embodiment, a bandwidth extension device 110 may be a device that generates an extended signal 13 based on an original signal 11. The original signal 11 may be an audio signal and may include a low-band signal. The original signal 11 may include a low-band signal of a time domain. The original signal 11 may include a low-band signal in which a full-band signal of the time domain is processed by a band-pass filter (e.g., a band-pass filter 720 of FIG. 7) and output. The extended signal 13 may be an audio signal and may include a full-band signal in which a high-band portion is restored. The bandwidth extension device 110 may convert the original signal 11 to a low-band spectrum of a frequency domain. The bandwidth extension device 110 may obtain a full-band spectrum from the low-band spectrum by using a bandwidth extension neural network (e.g., a bandwidth extension neural network 230 of FIG. 2). The bandwidth extension device 110 may convert the full-band spectrum to the time domain to generate the extended signal 13.

FIG. 2 is a diagram illustrating a bandwidth extension method according to an embodiment.

Referring to FIG. 2, according to an embodiment, a bandwidth extension device (e.g., the bandwidth extension device 110 of FIG. 1) may include a low-band frequency converter 210, the bandwidth extension neural network 230, and a full-band frequency inverse-converter 250. A low-band signal

$${s}_{LB}^{m} ( n )$$

(wherein n=0, . . . , (N_{LB}−1) and N_{LB} is the number of samples included in a frame of the low-band signal

$${s}_{LB}^{m} ( n ) )$$

may include an original signal (e.g., the original signal 11 of FIG. 1). The low-band signal

$${s}_{LB}^{m} ( n )$$

may be an audio signal frame, and m may represent an index of the frame. The low-band frequency converter 210 may perform conversion on the low-band signal

$${s}_{LB}^{m} ( n )$$

of the time domain, and may output a low-band spectrum

$${S}_{LB}^{m} ( k )$$

of the frequency domain (wherein k=0 . . . , (K_{LB}−1) and K_{LB} is the number of frequency bins of the low-band spectrum

$${S}_{LB}^{m} ( k ) .$$

The low-band frequency converter 210 may convert the low-band signal

$${s}_{LB}^{m} ( n )$$

to the low-band spectrum

$${S}_{LB}^{m} ( k )$$

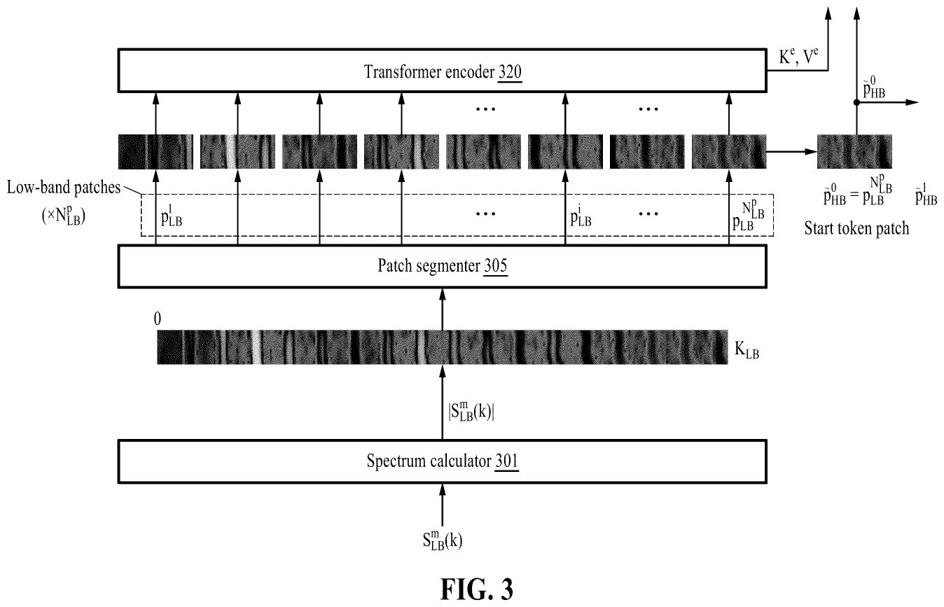

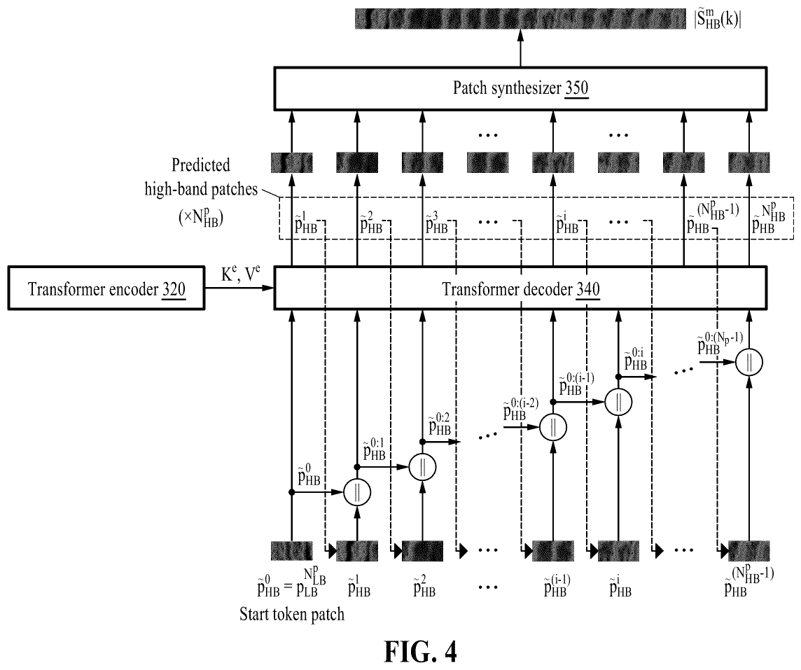

using a conversion method such as a fast Fourier transform (FFT) and a modified discrete cosine transform (MDCT). The bandwidth extension neural network 230 may include a transformer neural network. The transformer neural network may be a neural network that avoids a recurrence structure and uses an attention structure that assigns a weight to each element of an input sequence. The transformer neural network may include a transformer encoder (e.g., a transformer encoder 320 of FIG. 3) and a transformer decoder (e.g., a transformer decoder 340 of FIG. 4). The transformer encoder 320 and the transformer decoder 340 are described in detail with reference to FIGS. 3 to 7 below. The bandwidth extension neural network 230 may generate, based on the low-band spectrum

$${S}_{LB}^{m} ( k ) ,$$

a full-band spectrum

$${\tilde{S}}_{BWE}^{m} ( k )$$

(wherein k=0, . . . , (K_{FB}−1) and K_{FB} is the number of frequency bins of the full-band spectrum) in which a bandwidth is extended. The full-band spectrum may be a synthesis of a low-band spectrum and a high-band spectrum generated based on the low-band spectrum. The full-band frequency inverse-converter 250 may perform frequency inverse-conversion on the full-band spectrum

$${\tilde{S}}_{BWE}^{m} ( k )$$

to output a full-band signal

$${\tilde{s}}_{BWE}^{m} ( n )$$

(wherein n=0, . . . , (N_{FB}−1) and N_{FB} is the number of samples included in a frame of the full-band signal).

FIG. 3 is a diagram illustrating an operation of generating parameters, according to an embodiment.

Referring to FIG. 3, according to an embodiment, a bandwidth extension neural network (e.g., the bandwidth extension neural network 230 of FIG. 2) may include the transformer encoder 320 and a transformer decoder (e.g., the transformer decoder 340 of FIG. 4). A bandwidth extension device (e.g., the bandwidth extension device 110 of FIG. 1) may include a spectrum calculator 301 and a patch segmenter 305. The bandwidth extension device 110 may segment the low-band spectrum

$${S}_{LB}^{m} ( k )$$

into patches and may input the low-band spectrum

$${S}_{LB}^{m} ( k )$$

to the transformer encoder 320. The spectrum calculator 301 may calculate a magnitude component and a phase component of a spectrum. The spectrum calculator 301 may calculate the magnitude component and the phase component of the low-band spectrum

$${S}_{LB}^{m} ( k )$$

and may output a low-band magnitude spectrum

$$\vert {S}_{LB}^{m} ( k ) \vert$$

and a low-band phase spectrum

$$∡ {S}_{L B}^{m} ( k ) .$$

The low-band magnitude spectrum

$${S}_{LB}^{m} ( k )$$

and the low-band phase spectrum

$$∡ {S}_{L B}^{m} ( k )$$

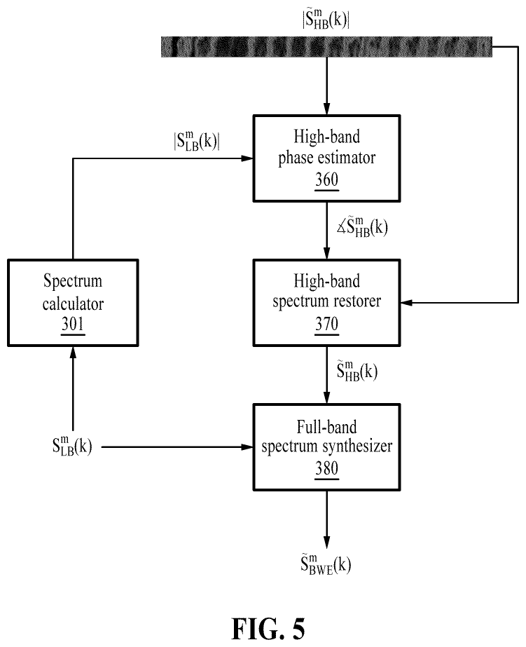

may be used to generate a full-band spectrum, which is described below with reference to FIG. 5. The low-band magnitude spectrum

$$\vert {S}_{LB}^{m} ( k ) \vert$$

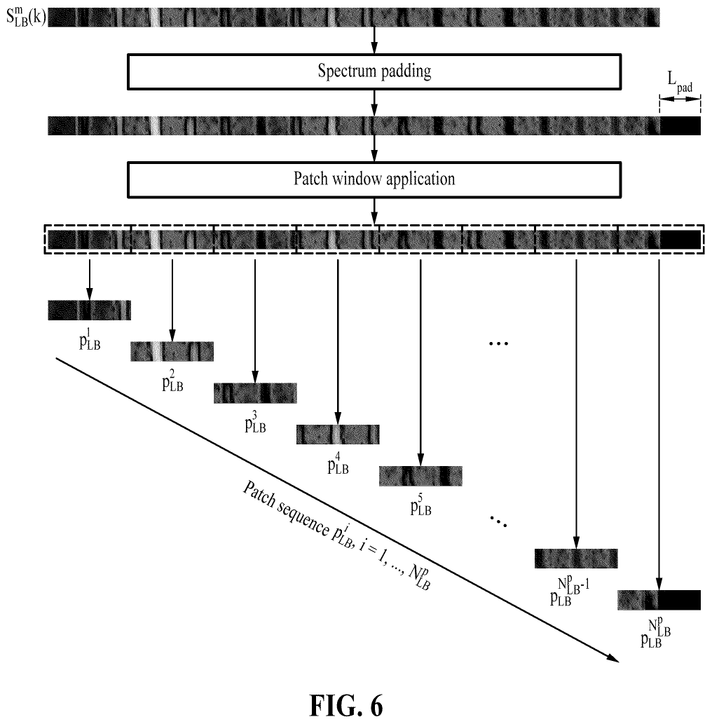

may be transmitted to the patch segmenter 305. The patch segmenter 305 may segment a signal and/or a spectrum into patches of a predetermined length. An operation of segmenting a spectrum and generating patches by the patch segmenter 305 is described in detail below with reference to FIG. 6. The patch segmenter 305 may segment the low-band magnitude spectrum

$$\vert {S}_{L B}^{m} ( k ) \vert$$

into low-band patches

$${p}_{LB}^{1 : {N}_{LB}^{p}}$$

(wherein

$${N}_{LB}^{p}$$

is the number of segmented low-band patches). The low-band patches

$${p}_{LB}^{1 : {N}_{LB}^{p}}$$

may be a sequence of consecutive low-band patches. For example, the low-band patches

$${p}_{LB}^{1 : {N}_{LB}^{p}}$$

may be a sequence of consecutive low-band patches from a first low-band patch

$${p}_{LB}^{1}$$

$$to a {N}_{{LB}_{- th}}^{p}$$

low-band patch

$${p}_{LB}^{{N}_{LB}^{p}} .$$

A low-band patch

$${p}_{LB}^{} \text{?}$$

$$\text{?} \text{indicates text missing or illegible when filed}$$

may be an i-th low-band patch. The low-band patches may have the same length. A length Lₚ of each low-band patch may represent the number of spectrum bins included in one low-band patch. A number

$${N}_{L B}^{p}$$

of low-band patches may be a number K_{LB} of frequency bins of the low-band spectrum divided by the length Lₚ of the low-band patch. The bandwidth extension device 110 may determine the

$${N}_{{LB}_{- th}}^{p}$$

low-band patch

$${p}_{LB}^{{N}_{LB}^{p}}$$

as a start token patch

$${\tilde{p}}_{HB}^{0}$$

for predicting a high-band patch.

According to an embodiment, the bandwidth extension device 110 may input the low-band patches

$${p}_{LB}^{1 : {N}_{LB}^{p}}$$

to the transformer encoder 320 to generate a key parameter K^{e} and a value parameter V^{e}. The transformer encoder 320 may generate the key parameter K^{e} and the value parameter V^{e} based on the low-band patches

$${p}_{LB}^{1 : {N}_{LB}^{p}} .$$

The key parameter K^{e} and the value parameter V^{e} may be calculated based on attention weights between the low-band patches

$${p}_{LB}^{1 : {N}_{LB}^{p}} .$$

The attention weight may represent how much each input element of an input sequence contributes to an output. The attention weight may be used in a process of training a neural network (e.g., the bandwidth extension neural network 230) and may determine the influence of the input element on the output. The key parameter K^{e} and the value parameter V^{e} may be transmitted to a transformer decoder (e.g., the transformer decoder 340 of FIG. 4) and used to predict high-band patches.

FIG. 4 is a diagram illustrating an operation of predicting a high-band patch, according to an embodiment.

Referring to FIG. 4, according to an embodiment, a bandwidth extension device (e.g., the bandwidth extension device 110) may use the transformer decoder 340 to predict a high-band patch

$${\tilde{p}}_{HB}^{1}$$

from a start token patch

$${\tilde{p}}_{HB}^{0} .$$

The transformer decoder 340 may predict a high-band patch from the start token patch

$${\tilde{p}}_{HB}^{0}$$

based on the key parameter K^{e} and the value parameter V^{e}.

$${\tilde{p}}_{HB}^{1}$$

may be a first predicted high-band patch. The bandwidth extension device 110 may concatenate the predicted high-band patch

$${\tilde{p}}_{HB}^{1}$$

with the start token patch \tilde{p}_{HB}⁰ to generate a patch sequence

$${\tilde{p}}_{HB}^{0 : 1} .$$

The bandwidth extension device 110 may generate from the predicted high-band patch

$${\tilde{p}}_{HB}^{1}$$

to the predicted high-band patch

$${\tilde{p}}_{HB}^{{N}_{HB}^{p}} .$$

According to an embodiment, the bandwidth extension device 110 may predict a first high-band patch (e.g., a predicted high-band patch

$${\tilde{p}}_{HB}^{i - 1} )$$

from a first patch sequence (e.g., a patch sequence

$${\tilde{p}}_{HB}^{0 : ( i - 2 )} )$$

using the transformer decoder 340. The bandwidth extension device 110 may concatenate the first patch sequence (e.g., the patch sequence

$${\tilde{p}}_{HB}^{0 : ( i - 2 )} )$$

with the first high-band patch (e.g., the predicted high-band patch

$${\tilde{p}}_{HB}^{i - 1} )$$

to generate a second patch sequence (e.g., a patch sequence

$${\tilde{p}}_{HB}^{0 : ( i - 1 )} ) .$$

The bandwidth extension device 110 may predict a second high-band patch (e.g., a predicted high-band patch

$${\tilde{p}}_{HB}^{i} )$$

from the second patch sequence (e.g., the patch sequence

$${\tilde{p}}_{HB}^{0 : ( i - 1 )} )$$

using the transformer decoder 340. The first high-band patch may include a previous high-band patch (e.g., the predicted high-band patch

$${\tilde{p}}_{HB}^{i - 1} {\tilde{p}}_{HB}^{i - 1} ) ,$$

and the second high-band patch may include a current high-band patch (e.g., the predicted high-band patch

$${\tilde{p}}_{HB}^{i} ) .$$

The bandwidth extension device 110 may repeat the above-described operations while increasing an index (e.g., i) of the predicted high-band patch until the index becomes

$${N}_{HB}^{p}$$

(where

$${N}_{HB}^{p}$$

is the number of predicted high-band patches).

According to an embodiment, the bandwidth extension device 110 may include a patch synthesizer 350. The bandwidth extension device 110 may synthesize (e.g., concatenate) predicted high-band patches

$${\tilde{p}}_{HB}^{1 : {N}_{HB}^{p}}$$

using the patch synthesizer 350 to generate a high-band magnitude spectrum

$$\vert {\tilde{S}}_{HB}^{m} ( k ) \vert$$

(wherein k=0, . . . , (K_{HB}−1) and K_{HB} is the number of frequency bins of the high-band spectrum). The number K_{HB} of frequency bins of the high-band spectrum may be a value obtained by multiplying the length Lₚ of each predicted high-band patch by a number

$${N}_{HB}^{p}$$

of predicted high-band patches.

FIG. 5 is a diagram illustrating an operation of generating a full-band spectrum, according to an embodiment.

Referring to FIG. 5, according to an embodiment, a bandwidth extension device (e.g., the bandwidth extension device 110 of FIG. 1) may include a high-band phase estimator 360, a high-band spectrum restorer 370, and a full-band spectrum synthesizer 380. The bandwidth extension device 110 may generate a high-band spectrum based on the predicted high-band patches

$${\tilde{p}}_{HB}^{1 : {N}_{HB}^{p}} .$$

The bandwidth extension device 110 may synthesize (e.g., concatenate) the predicted high-band patches

$${\tilde{p}}_{HB}^{1 : {N}_{HB}^{p}}$$

using the patch synthesizer 350 to generate the high-band magnitude spectrum

$$\vert {\tilde{S}}_{HB}^{m} ( k ) \vert$$

(wherein k=0, . . . , (K_{HB}−1) and K_{HB} is the number of frequency bins of the high-band spectrum). The high-band phase estimator 360 may output a high-band phase spectrum

$$∡ {\tilde{S}}_{HB}^{m} ( k )$$

based on the high-band magnitude spectrum

$$\vert {\tilde{S}}_{HB}^{m} ( k ) \vert .$$

The high-band phase estimator 360 may estimate a phase component of the high-band spectrum based on at least one of the low-band magnitude spectrum

$$\vert {S}_{LB}^{m} ( k ) \vert$$

and the high-band magnitude spectrum

$$\vert {\tilde{S}}_{HB}^{m} ( k ) \vert .$$

The high-band phase estimator 360 may estimate the phase component of the high-band spectrum using a method such as a Griffin-Lim algorithm and a neural network-based algorithm. There are various methods for the high-band phase estimator 360 to estimate the phase component of the high-band spectrum and output the high-band phase spectrum

$$∡ {\tilde{S}}_{H B}^{m} ( k ) ,$$

and the methods are not limited to the examples described above. The bandwidth extension device 110 may generate a high-band spectrum

$${\tilde{S}}_{H B}^{m} ( k )$$

based on the high-band magnitude spectrum

$$\vert {\tilde{S}}_{HB}^{m} ( k ) \vert$$

and the high-band phase spectrum

$$∡ {\tilde{S}}_{H B}^{m} ( k ) .$$

The high-band spectrum restorer 370 may generate the high-band spectrum

$${\tilde{S}}_{H B}^{m} ( k )$$

using the high-band magnitude spectrum

$$\vert {\tilde{S}}_{HB}^{m} ( k ) \vert$$

and the high-band phase spectrum

$$∡ {\tilde{S}}_{H B}^{m} ( k ) .$$

For example, the high-band spectrum restorer 370 may perform a Fourier transform on the high-band magnitude spectrum

$$\vert {\tilde{S}}_{HB}^{m} ( k ) \vert$$

and the high-band phase spectrum

$$∡ {\tilde{S}}_{H B}^{m} ( k )$$

to express them as complex-numbered signals, may calculate a complex spectrum, and may perform an inverse Fourier transform to generate the high-band spectrum

$${\tilde{S}}_{H B}^{m} ( k ) .$$

The high-band spectrum restorer 370 may generate the high-band spectrum

$${\tilde{S}}_{H B}^{m} ( k )$$

using Equation 1 below.

$${\tilde{S}}_{H B}^{m} ( k ) = \vert {\tilde{S}}_{BWE}^{m} ( k ) \vert exp ( j ∡ {\tilde{S}}_{H B}^{m} ( k ) ) = \vert {\tilde{S}}_{BWE}^{m} ( k ) \vert cos ( ∡ {\tilde{S}}_{H B}^{m} ( k ) ) + j \vert {\tilde{S}}_{BWE}^{m} ( k ) \vert sin ( ∡ {\tilde{S}}_{H B}^{m} ( k ) ) , j = \sqrt{- 1 \cdot } \qquad [ Equation 1 ]$$

The high-band spectrum

$${\tilde{S}}_{HB}^{m} ( k )$$

may be a high-band spectrum that is predicted by the bandwidth extension device 110 from the low-band spectrum

$${S}_{LB}^{m} ( k )$$

using a bandwidth extension method. The full-band spectrum synthesizer 380 may synthesize the low-band spectrum

$${S}_{LB}^{m} ( k )$$

with the high-band spectrum

$${\tilde{S}}_{HB}^{m} ( k )$$

to generate the full-band spectrum

$${\tilde{S}}_{BWE}^{m} ( k ) .$$

The full-band spectrum

$${\tilde{S}}_{BWE}^{m} ( k )$$

generated by the full-band spectrum synthesizer 380 may be a result of connecting the low-band spectrum

$${S}_{LB}^{m} ( k )$$

to the high-band spectrum

$${\tilde{S}}_{HB}^{m} ( k ) ,$$

as shown in Equation 2 below.

$${\tilde{S}}_{BWE}^{m} ( k ) = \{ \begin{matrix}{S}_{LB}^{m} ( k ) , & k = 0 , … , ( {K}_{LB} - 1 ) \\ {\tilde{S}}_{HB}^{m} ( k ) , & k = {K}_{LB} , … , ( {K}_{FB} - 1 )\end{matrix} \qquad [ Equation 2 ]$$

The bandwidth extension device 110 may generate a full-band signal corresponding to the full-band spectrum

$${\tilde{S}}_{BWE}^{m} ( k ) .$$

The full-band spectrum

$${\tilde{S}}_{BWE}^{m} ( k )$$

may be converted into the full-band signal by a full-band frequency inverse-converter (e.g., the full-band frequency inverse-converter 250 of FIG. 2).

FIG. 6 is a diagram illustrating a patch segmentation operation according to an embodiment.

Referring to FIG. 6, according to an embodiment, a bandwidth extension device (e.g., the bandwidth extension device 110 of FIG. 1) may obtain low-band patches in which the low-band spectrum

$${S}_{LB}^{m} ( k )$$

corresponding to a low-band signal (e.g., the original signal 11 of FIG. 1) is segmented. The bandwidth extension device 110 may obtain the low-band patches using a patch segmenter (e.g., the patch segmenter 305 of FIG. 3). The patch segmenter 305 may segment a signal and/or a spectrum into patches of a predetermined length. The bandwidth extension device 110 may perform spectrum padding on the low-band spectrum

$${S}_{LB}^{m} ( k ) .$$

The spectrum padding may be a process of adding L_{pad} frequency bins such that each low-band patch has the same patch length (e.g., Lₚ) when the number K_{LB} of frequency bins of the low-band spectrum

$${S}_{LB}^{m} ( k )$$

is not exactly divisible by the length Lₚ of the low-band patch (e.g., when K_{LB} is not a multiple of Lₚ). For example, the bandwidth extension device 110 may perform the spectrum padding by adding 0 to the low-band spectrum

$${S}_{LB}^{m} ( k ) ,$$

adding a last frequency bin

$${S}_{LB}^{m} ( {K}_{LB} - 1 ) .$$

of the low-band spectrum

$${S}_{L B}^{m} ( k ) ,$$

or adding an adjacent frequency bin interval. The spectrum padding is an optional process and may not be essential. The patch segmenter 305 may obtain the low-band patches by applying a patch window to the low-band spectrum

$${S}_{L B}^{m} ( k ) .$$

The patch window may be used to cut a specific portion of a signal into smaller pieces and interpret the specific portion of a signal. The patch window that the patch segmenter 305 applies to the low-band spectrum

$${S}_{L B}^{m} ( k )$$

may have an overlapping interval. Although FIG. 6 illustrates that the patch window is a rectangular window, the shape of the patch window is not limited thereto. For example, the patch window may be implemented as a hamming window. The bandwidth extension device 110 may segment the low-band spectrum

$${S}_{L B}^{m} ( k )$$

into low-band patches

$${p}_{LB}^{1 : {N}_{LB}^{p}}$$

and may input them to a transformer encoder (e.g., the transformer encoder 320 of FIG. 3).

FIG. 7 is a diagram illustrating an operation of training a neural network, according to an embodiment.

Referring to FIG. 7, according to an embodiment, a bandwidth extension neural network 730 (e.g., the bandwidth extension neural network 230 of FIG. 2) may be trained to increase the accuracy of bandwidth extension. The bandwidth extension device 110 may train the bandwidth extension neural network 730. Hereinafter, it is assumed that the bandwidth extension device 110 trains the bandwidth extension neural network 730, but the training of the bandwidth extension neural network 730 may be performed by an external device.

According to an embodiment, the bandwidth extension device 110 may input an original full-band signal s^{m}(n) corresponding to an m-th frame to the band-pass filter 720 to obtain the low-band signal

$${s}_{L B}^{m} ( n ) .$$

The original full-band signal s^{m}(n) may be converted into an original full-band spectrum S^{m}(k) (wherein k=0, . . . , (K_{FB}−1) and K_{FB} is the number of frequency bins of a full-band spectrum) by the full-band frequency converter 760. The full-band frequency converter 760 may convert the original full-band signal s^{m}(n) to the original full-band spectrum S^{m}(k) using a conversion algorithm such as an FFT and an MDCT. The full-band spectrum S^{m}(k) may be transmitted to a loss function calculator 740 and used to train the bandwidth extension neural network 730. A low-band frequency converter 710 (e.g., the low-band frequency converter 210 of FIG. 2) may convert the low-band signal

$${s}_{L B}^{m} ( n )$$

of a time domain to output the low-band spectrum

$${S}_{L B}^{m} ( k )$$

of a frequency domain. The bandwidth extension neural network 730 may generate the full-band spectrum

$${\tilde{S}}_{BWE}^{m} ( k )$$

with an extended bandwidth based on the low-band spectrum

$${S}_{L B}^{m} ( k ) .$$

The full-band spectrum

$${\tilde{S}}_{BWE}^{m} ( k )$$

may be transmitted to the loss function calculator 740 and used to train the bandwidth extension neural network 730. The loss function calculator 740 may calculate and output a loss between the original full-band spectrum S^{m}(k) and the full-band spectrum

$${\tilde{S}}_{BWE}^{m} ( k ) .$$

For example, the loss function calculator 740 may calculate and output a coupling loss such as a spectrum distortion loss, a mel-filterbank distortion loss, a perceptual loss based on a psycho-acoustic model, and a discriminator loss based on a generative adversarial network (GAN). However, the method of calculating the loss between the original full-band spectrum S^{m}(k) and the full-band spectrum

$${\tilde{S}}_{BWE}^{m} ( k )$$

by the loss function calculator 740 is not limited to the above example. The bandwidth extension neural network 730 may be trained according to the loss calculated by the loss function calculator 740, thereby generating the full-band spectrum

$${\tilde{S}}_{BWE}^{m} ( k )$$

similar to the original full-band spectrum S^{m}(k).

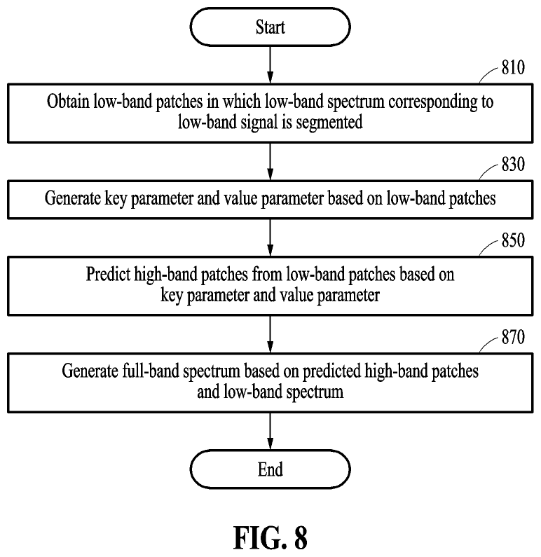

FIG. 8 is a flowchart illustrating a method of extending a bandwidth of an audio signal, according to an embodiment.

Referring to FIG. 8, according to an embodiment, operations 810 to 870 may be operations performed by the bandwidth extension device 110 of FIG. 1 described with reference to FIGS. 1 to 7.

In operation 810, the bandwidth extension device 110 may obtain low-band patches in which a low-band spectrum corresponding to a low-band signal is segmented. The bandwidth extension device 110 may obtain the low-band patches by applying a patch window to the low-band spectrum.

In operation 830, the bandwidth extension device 110 may generate a key parameter and a value parameter based on the low-band patches. The bandwidth extension device 110 may input the low-band patches to a transformer encoder (e.g., the transformer encoder 320 of FIG. 3) to generate the key parameter and the value parameter.

In operation 850, the bandwidth extension device 110 may predict high-band patches from the low-band patches based on the key parameter and the value parameter. The bandwidth extension device 110 may predict a first high-band patch from a first low-band patch using a transformer decoder (e.g., the transformer decoder 340 of FIG. 4). The bandwidth extension device 110 may generate a patch sequence by concatenating the first high-band patch with a second low-band patch. The bandwidth extension device 110 may predict a second high-band patch from the patch sequence using the transformer decoder.

In operation 870, the bandwidth extension device 110 may generate a full-band spectrum based on predicted high-band patches and the low-band spectrum. The bandwidth extension device 110 may generate a high-band spectrum based on the predicted high-band patches. The bandwidth extension device 110 may generate the full-band spectrum by synthesizing the low-band spectrum with the high-band spectrum.

Operations 810 to 870 may be performed sequentially but are not limited thereto. For example, two or more operations may be performed in parallel.

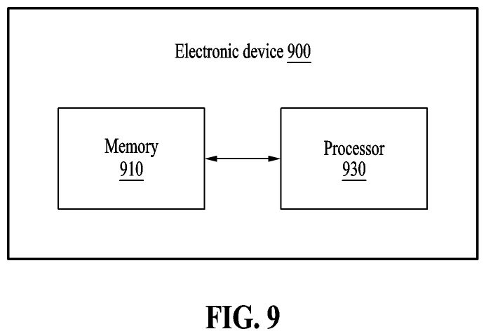

FIG. 9 is a schematic block diagram of an electronic device according to an embodiment.

Referring to FIG. 9, according to an embodiment, an electronic device 900 (e.g., the bandwidth extension device 110 of FIG. 1) may include a memory 910 and a processor 930.

The memory 910 may store instructions (or programs) executable by the processor 930. For example, the instructions may include instructions for executing operations of the processor 930 and/or operations of each component of the processor 930.

The memory 910 may include one or more computer-readable storage media. The memory 910 may include non-volatile storage elements (e.g., a magnetic hard disc, an optical disc, a floppy disc, flash memory, electrically programmable memory (EPROM), and electrically erasable and programmable memory (EEPROM)).

The memory 910 may be non-transitory media. The term “non-transitory” may indicate that a storage medium is not implemented as a carrier wave or a propagated signal. However, the term “non-transitory” should not be construed as meaning that the memory 910 is immovable.

The processor 930 may process data stored in the memory 910. The processor 930 may execute computer-readable code (e.g., software) stored in the memory 910 and instructions triggered by the processor 930.

The processor 930 may be a data processing device implemented by hardware including a circuit having a physical structure to perform desired operations. The desired operations may include, for example, code or instructions in a program.

The data processing device implemented by hardware may include, for example, a microprocessor, a central processing unit (CPU), a processor core, a multi-core processor, a multiprocessor, an ASIC, and an FPGA.

The processor 930 may cause the electronic device 900 to perform one or more operations by executing the code and/or instructions stored in the memory 910. The operations performed by the electronic device 900 may be substantially the same as the operations performed by the bandwidth extension device 110 described with reference to FIGS. 1 to 9. Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method comprising:
obtaining low-band patches in which a low-band spectrum corresponding to a low-band signal is segmented;
generating a key parameter and a value parameter based on the low-band patches;
predicting high-band patches from the low-band patches based on the key parameter and the value parameter; and
generating a full-band spectrum based on the predicted high-band patches and the low-band spectrum.

2. The method of claim 1, wherein
the generating of the key parameter and the value parameter comprises inputting the low-band patches to a transformer encoder to generate the key parameter and the value parameter.

3. The method of claim 1, wherein
the obtaining of the low-band patches comprises applying a patch window to the low-band spectrum to obtain the low-band patches.

4. The method of claim 1, wherein
the key parameter and the value parameter are calculated based on attention weights between the low-band patches.

5. The method of claim 1, wherein
the predicting comprises:
predicting a first high-band patch from a first patch sequence using a transformer decoder; and
generating a second patch sequence by concatenating the first patch sequence with the first high-band patch.

6. The method of claim 5, further comprising:
predicting a second high-band patch from the second patch sequence using the transformer decoder.

7. The method of claim 6, wherein
the first high-band patch comprises a previous high-band patch, and
the second high-band patch comprises a current high-band patch.

8. The method of claim 1, wherein
the generating of the full-band spectrum comprises:
generating a high-band spectrum based on the predicted high-band patches; and
synthesizing the low-band spectrum with the high-band spectrum to generate the full-band spectrum.

9. The method of claim 8, wherein
the generating of the high-band spectrum comprises:
generating a high-band magnitude spectrum by synthesizing the predicted high-band patches;
estimating a high-band phase spectrum based on the high-band magnitude spectrum; and
generating the high-band spectrum based on the high-band magnitude spectrum and the high-band phase spectrum.

10. The method of claim 1, further comprising:
generating a full-band signal corresponding to the full-band spectrum.

11. A device comprising:
a memory comprising instructions; and
a processor electrically connected to the memory and configured to execute the instructions,
wherein, when the instructions are executed by the processor, the processor is configured to control a plurality of operations,
wherein the plurality of operations comprises:
obtaining low-band patches in which a low-band spectrum corresponding to a low-band signal is segmented;
generating a key parameter and a value parameter based on the low-band patches;
predicting high-band patches from the low-band patches based on the key parameter and the value parameter; and
generating a full-band spectrum based on the predicted high-band patches and the low-band spectrum.

12. The device of claim 11, wherein
the generating of the key parameter and the value parameter comprises inputting the low-band patches to a transformer encoder to generate the key parameter and the value parameter.

13. The device of claim 11, wherein
the obtaining of the low-band patches comprises applying a patch window to the low-band spectrum to obtain the low-band patches.

14. The device of claim 11, wherein
the key parameter and the value parameter are calculated based on attention weights between the low-band patches.

15. The device of claim 11, wherein
the predicting comprises:
predicting a first high-band patch from a first patch sequence using a transformer decoder; and
generating a second patch sequence by concatenating the first patch sequence with the first high-band patch.

16. The device of claim 15, wherein
the plurality of operations further comprises predicting a second high-band patch from the second patch sequence using the transformer decoder.

17. The device of claim 16, wherein
the first high-band patch comprises a previous high-band patch, and
the second high-band patch comprises a current high-band patch.

18. The device of claim 11, wherein
the generating of the full-band spectrum comprises:
generating a high-band spectrum based on the predicted high-band patches; and
synthesizing the low-band spectrum with the high-band spectrum to generate the full-band spectrum.

19. The device of claim 11, wherein
the generating of the high-band spectrum comprises:
generating a high-band magnitude spectrum by synthesizing the predicted high-band patches;
estimating a high-band phase spectrum based on the high-band magnitude spectrum; and
generating the high-band spectrum based on the high-band magnitude spectrum and the high-band phase spectrum.

20. The device of claim 11, wherein
the plurality of operations further comprises generating a full-band signal corresponding to the full-band spectrum.
